(19) United States
(12) Patent Application Publication
(10) Pub. No.: US 2018/0108945 A1
(43) Pub. Date: Apr. 19, 2018

(54) LITHIUM BATTERY, SOLID ELECTROLYTE MEMBRANE AND THEIR MANUFACTURING METHODS THEREOF

(71) Applicant: Institute of Nuclear Energy Research, Atomic Energy Council, Executive Yuan, R.O.C., Taoyuan (TW)

(72) Inventors: CHI-HUNG SU, Taoyuan (TW); CHAO-YEN KUO, Taoyuan (TW); DER-JUN JAN, Taoyuan (TW)

(21) Appl. No.: 15/430,936

(22) Filed: Feb. 13, 2017

(30) Foreign Application Priority Data
Oct. 14, 2016 (TW) 105133327

(51) Int. Cl. H01M 10/0565; H01M 10/0585; H01M 10/0525

(52) U.S. Cl. CPC H01M 10/0565; H01M 10/0525; H01M 10/0585

(57) ABSTRACT

The invention provides a method for manufacturing solid electrolyte membrane. The manufacturing method includes the following steps. A solution is provided. The solution is heated and mixed with an electrolytic solution and a lithium salt. Then, a solid-state polymer material is added to the solution. Then, a heating and stirring step is performed so as to form a viscous mass. Then, a forming step is performed to form a solid electrolyte membrane. In addition, a lithium battery and manufacturing method thereof is provided.

### CROSS REFERENCE TO RELATED APPLICATION

This application also claims priority to Taiwan Patent Application No. 105133327 filed in the Taiwan Patent Office on Oct. 14, 2016, the entire content of which is incorporated herein by reference.

### FIELD OF THE INVENTION

The present invention relates to a lithium battery, a solid electrolyte membrane and the manufacturing methods thereof, more particularly, to a lithium battery using solid electrolyte membrane and the manufacturing method thereof.

### BACKGROUND OF THE INVENTION

With the progress of science and technology and the discovery of new materials, there are various types of batteries being developed, and, with the increasing popularity and availability of portable electronic devices, such as mobile phones and notebook computers, the demand for batteries that are small in size, light weight, and can offer high electrical performance is increasing exponentially. In response to such demand, the lithium-ion battery has attracted great attention due to its high energy density and rapid charging characteristics, and therefor has been widely used. Nevertheless, in most electrochemical devices, such as primary batteries, secondary batteries, and capacitors, liquid electrolytes had been widely and commonly used as the conductive material. However, since the use of liquid electrolytes in electrochemical devices can lead to the problems including: liquid leakage hazard, lack of long-term operation stability, easily ignited and burn, poor safety and low reliability, the electrochemical devices using liquid electrolyte cannot fully meet the safety requirements of large-scale industrial energy storage.

Nowadays, the ion conductivity of solid electrolytes that are made of inorganic ceramic materials is ranged between 1×10⁻⁶ S/cm and 1×10⁻⁷ S/cm, and it is general to employ a RF magnetron sputtering method to manufacture a membrane from such solid electrolytes for an all-solid-state battery, such as lithium batteries. Since such manufacturing processes are required to be performed in vacuum environment, not only the manufacturing processes can be a technically challenging task, but also the equipment for enabling such manufacturing processes can be very costly. Consequently, the cost for manufacturing all-solid-state battery can be very expensive.

On the other hand, the methods for manufacturing polymer solid electrolytes that are currently available can be very complicated in process, which can include solution casting method, porous osmosis membrane method, and in-situ crosslink method, and so on. In addition, since operationally the process requires to soak the film in electrolyte and also to perform a heating or a photo-polymerization procedure upon precursors, not only the resulting process can be very complex, but also it can be difficult to ensure good quality control. Thus, it is in need of an improve process that can produce polymer solid electrolyte in a simplified manner, while improving the effectiveness in view of solid lithium battery manufacture and assembly.

### SUMMARY OF THE INVENTION

The present invention provides a simple and rapid method for manufacturing solid electrolyte membrane.

The present invention provides a method for manufacturing all-solid-state batteries that are safe to use and are built with high energy density. In an embodiment, a solid electrolyte membrane is manufactured and used in an all-solid-state battery, by that the cost for manufacturing the all-solid-state battery is reduce since there is neither separator membrane nor electrolytic solution needed to be used in the all-solid-state battery, and also, since the solid electrolyte membrane can be laminated between electrodes, the convenience regarding to the assembling of the all-solid-state battery is improved.

The present invention provides an all-solid-state battery which uses a solid electrolyte membrane to replace the use of conventional separator membrane and electrolytic solution.

In an embodiment, the present invention provides a manufacturing method for solid electrolyte membrane, which comprises the steps of: providing a solution, which is formed by heating a mixture of an electrolytic solution and a lithium salt; adding a solid-state polymer material to the solution, while enabling the weight percentage of the solid-state polymer material in the solution to be maintained within 10%˜30%; performing a heating and stirring process so as to dissolve the solid-state polymer material in the solution to form a viscous mass; performing a forming process for curing and forming the viscous mass into a solid electrolyte membrane.

In an embodiment, the present invention provides a manufacturing method for an all-solid-state battery, which comprises a procedure for manufacturing a solid electrolyte membrane and a lamination procedure. In addition, the procedure for manufacturing a solid electrolyte membrane comprises the steps of: providing a solution, which is formed by heating a mixture of an electrolytic solution and a lithium salt; adding a solid-state polymer material to the solution, while enabling the weight percentage of the solid-state polymer material in the solution to be maintained within 10%˜30%; performing a heating and stirring process so as to dissolve the solid-state polymer material in the solution to form a viscous mass; performing a forming process for curing and forming the viscous mass into a solid electrolyte membrane. The lamination procedure comprises a step of: attaching a first electrode and a second electrode respectively to the two sides of the solid electrolyte membrane, while allowing the first electrode and the second electrode to have opposite polarity.

The present invention provides an all-solid-state battery, which comprises: a solid electrolyte membrane, a first electrode and a second electrode. In an embodiment, the first electrode and the second electrode are attached respectively to the two sides of the solid electrolyte membrane, while allowing the first electrode and the second electrode to have opposite polarity; and the solid electrolyte membrane is manufacturing from a viscous mass that is formed by heating and stirring a solution added with a solid-state polymer material so as to dissolve the solid-state polymer material in the solution. Moreover, the solution is formed by heating a mixture of an electrolytic solution and a lithium salt, and the weight percentage of the solid-state polymer material in the solution is maintained within 10%˜30%.

In the all-solid-state battery, the solid electrolyte membrane and the manufacturing methods thereof that are provided in the present invention, no only the solid electrolyte membrane with ion conductivity larger than 1×10⁻⁴ S/cm that can function as an electrolyte layer is provided, but also the solid electrolyte membrane is able to function as a separator membrane by the characteristic of the solid polymer material doped in the solid electrolyte membrane. To sump up, the solid electrolyte membrane provided in the present invention can function as the combination of an electrolyte layer and a separator membrane.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart depicting steps performed in a manufacturing method for an all-solid-state battery according to the present invention.

FIG. 2 is a flow chart depicting steps performed in a manufacturing method for a solid electrolyte membrane according to the present invention.

FIG. 3 is a schematic diagram showing an all-solid-state battery according to an embodiment of the present invention.

FIG. 4 and FIG. 5 are diagrams showing charging/discharging tests using an electrolyte membrane of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

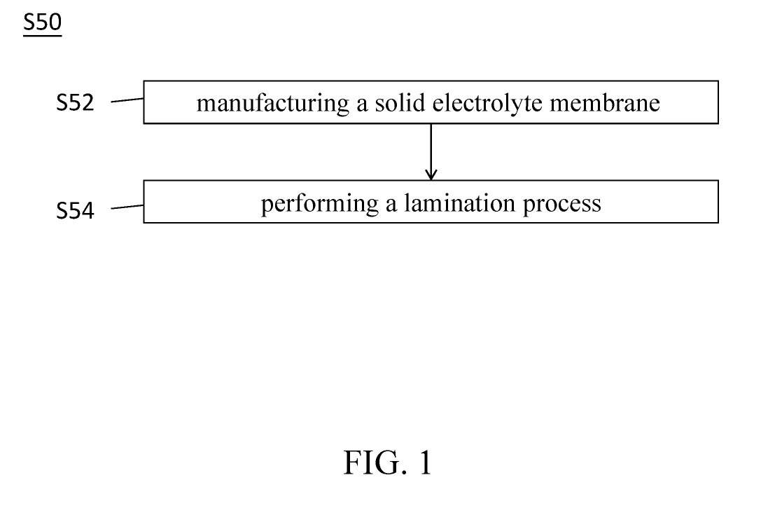

Please refer to FIG. 1, which is a flow chart depicting steps performed in a manufacturing method for an all-solid-state battery according to the present invention.

In FIG. 1, a manufacturing method for an all-solid-state battery S50 is disclosed, which comprises the steps of:
step S52: manufacturing a solid electrolyte membrane; and
step S54: performing a lamination process.

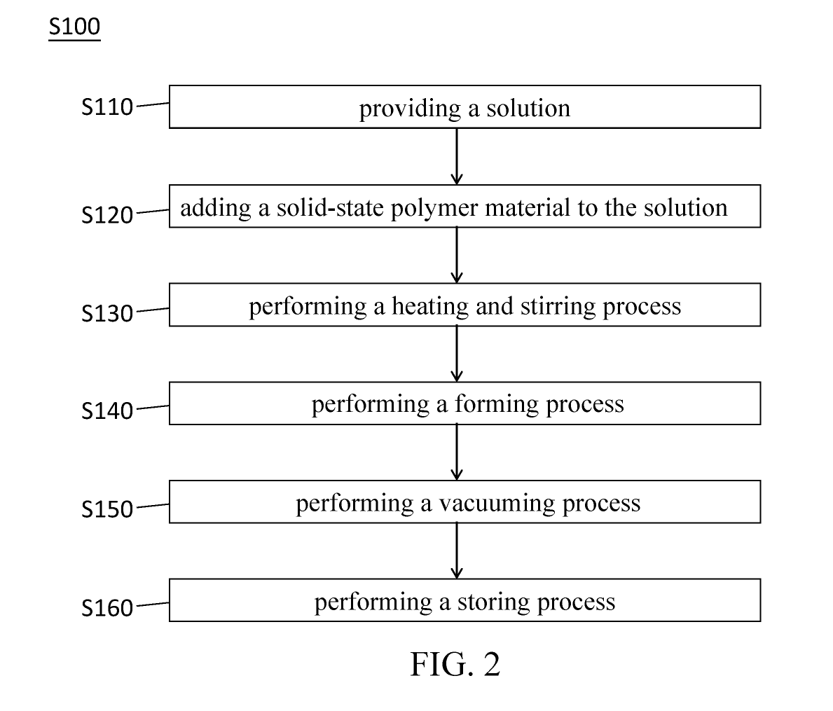

Please refer to FIG. 2, which is a flow chart depicting steps performed in a manufacturing method for a solid electrolyte membrane according to the present invention. As shown in FIG. 2, the method for manufacturing solid electrolyte membrane S100 further comprises the step S110˜S160.

At step S110, a solution is provided, while the solution is formed by heating a mixture of an electrolytic solution and a lithium salt. In an embodiment, the electrolytic solution is a solution selected from the group consisting of: a solution of ethylene carbonate, a solution of propylene carbonate, a solution of sulfolane, and a solution of succinonitirle; and the lithium salt is a material selection selected from the group consisting of: LiPF₆, LiClO₄, and LiTFSI. In addition, the concentration of the lithium salt in the solution is ranged between 1 M ˜2 M.

At step S120, a solid-state polymer material is added to the solution, and in an embodiment the weight percentage of the solid-state polymer material in the solution is maintained within 10%˜30%; and the solid polymer material is a material selected from the group consisting of: polyacrylonitrile, methyl methacrylate, polyvinylidene fluoride, and vinylidene fluoride-hexafluoropropylene. It is noted that in a real-world experiment, the weight percentage of the solid-state polymer material in the solution is maintained within 10%˜15%, which can be changed at will according to actual requirement.

At step S130, a heating and stirring process is performed so as to dissolve the solid-state polymer material in the solution to form a viscous mass. In an embodiment, the temperature is controlled to be ranged between 100° C. and 150° C. in the heating and stirring process. Nevertheless, in a real-world experiment, the temperature is controlled to be ranged between 115° C. and 135° C. in the heating and stirring process, and similarly, that can be changed at will according to actual requirement.

At step S140, a forming process is performed for curing and forming the viscous mass into a solid electrolyte membrane. In an embodiment, the forming process further comprises the steps of: coating the viscous mass on a release paper. Moreover, the coating of the viscous mass can be performed using a coating blade, and after the viscous mass that is being coated on the release paper by the coating blade is cured, a solid electrolyte membrane can be formed, whereas the time for curing the solid electrolyte membrane is less than 10 min.

At step S150, a vacuuming process is performed for removing moisture contained in the solid electrolyte membrane. In an embodiment, the solid electrolyte membrane is situated in a vacuum environment for 2 hr so as to remove the moisture contained in the solid electrolyte membrane.

At step S160, a storing process is performed for removing oxygen contained in the solid electrolyte membrane by storing the solid electrolyte membrane in an inert environment.

After the step S110˜S160, a transparent film-like solid electrolyte membrane is prepared and provided, using which not only the solid electrolyte membrane with ion conductivity larger than 1×10⁻⁴ S/cm that can function as an electrolyte layer, but also the solid electrolyte membrane is able to function as a separator membrane by the characteristic of the solid polymer material doped in the solid electrolyte membrane. To sum up, the solid electrolyte membrane provided in the present invention can function as the combination of an electrolyte layer and a separator membrane.

In a real-world experiment, the electrolyte solution used is a solution of sulfolane, the the lithium salt used is LiClO₄, and the solid polymer material used is polyacrylonitrile, that are mixed in a weight ratio of 82:7:11. Moreover, the temperature in the heating and stirring process is controlled to be ranged between 115° C. and 135° C. for enabling the solution to form the viscous mass. After the viscous mass is achieved, a coating blade of 0.2 mm in thickness is used for coating the viscous mass on a release paper, and after the viscous mass on the release paper is put to cure for time period that can be less than 10 min, a solid elelctrolyte membrane can be formed.

In a performance test, a piece of the solid elelctrolyte membrane that is about 1 cm² in size is cut and put into a battery cell for alternating-current impedance measurement. From the resulting impedance spectroscopy, the ion conductivity larger than 1×10⁻⁴ S/cm of the solid elelctrolyte membrane in room temperature is about 1×10⁻⁴ S/cm, while the electrochemical window of the solid elelctrolyte membrane that is measured using a stainless electrode and a lithium-doped electrode is 5V. Thereby, the solid elelctrolyte membrane can be proved to have good thermal stability and good electrochemical characteristic of wide electrochemical window.

In FIG. 1, the lamination procedure S54 is performed for attaching a first electrode and a second electrode respectively to the two sides of the solid electrolyte membrane, while allowing the first electrode and the second electrode to have opposite polarity. In an embodiment, the attaching of the first and the second electrodes can be enabled by a means of blade coating or magnetron sputtering. In addition, in the lamination procedure the solid elelctrolyte membrane can be cut into various sizes and shapes according to actual requirement.

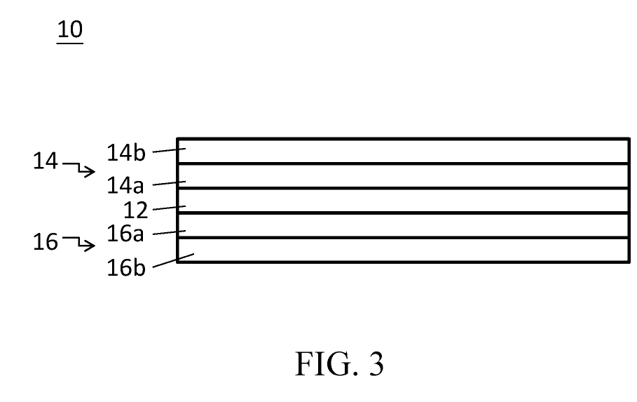

Please refer to FIG. 3, which is a schematic diagram showing an all-solid-state battery according to an embodiment of the present invention. In FIG. 3, the all-solid-state battery 10 includes a solid elelctrolyte membrane 12, a first electrode 14 and a second electrode 16, whereas the solid elelctrolyte membrane 12 is manufactured using the method of FIG. 2 and thus is not described further herein.

In an embodiment, each of the first electrode 14 and the second electrode 16 includes a set layer, i.e. 14b or 16b and an active material, i.e. 14a or 16a; and the active material 14a, 16a is a material selection selected from the group consisting of: LiMn₂O₄, LiCoO₂, LiFePO₄, LiNiO₂, Li _{1.2}Ni_{0.13}Mn_{0.54}Co_{0.13}O₂, S/PAN, S/C, C, Si, SnO₂, TiO₂, Li, and the derivatives, alloys and compounds thereof.

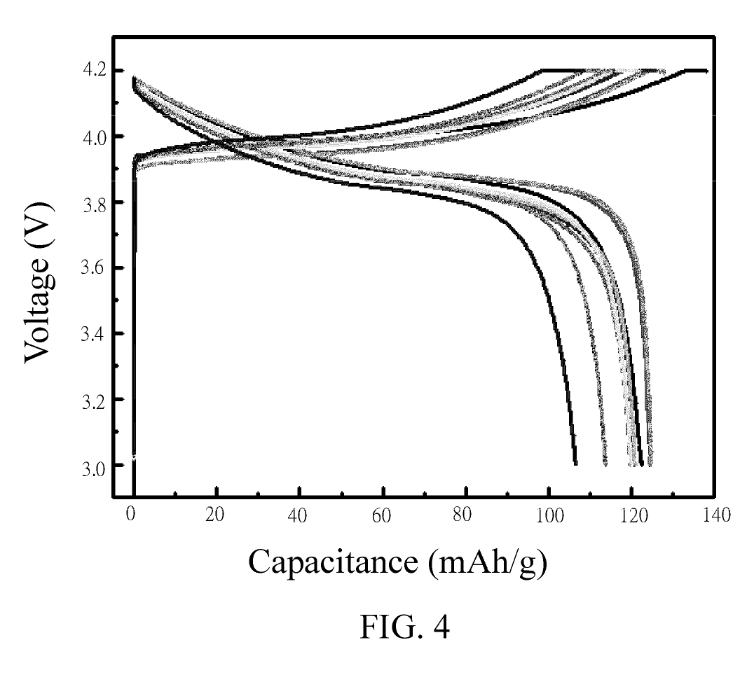

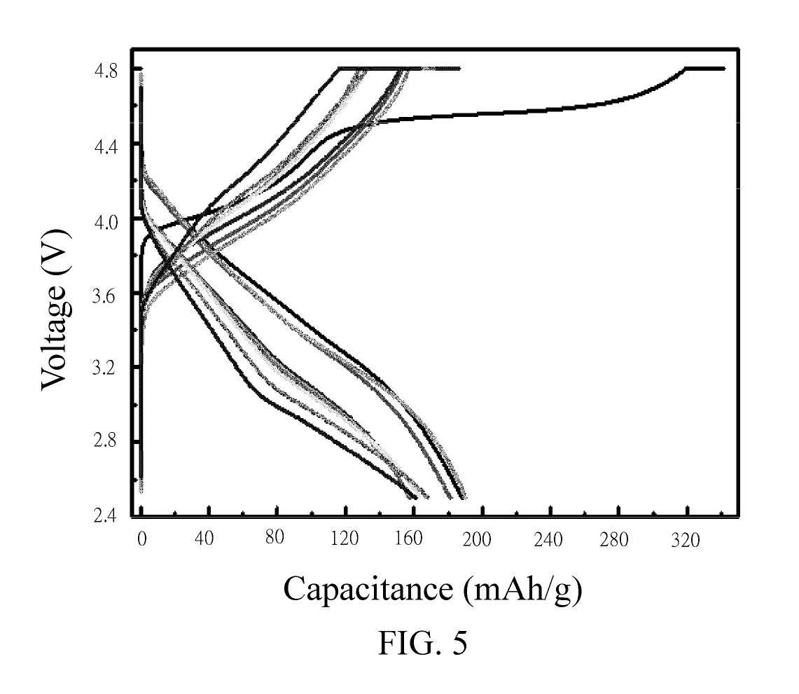

FIG. 4 and FIG. 5 are diagrams showing charging/discharging tests using an electrolyte membrane of the present invention. It is noted that LiCoO₂ is used in the test of FIG. 4 and LiNiO₂, Li_{1.2}Ni_{0.13}Mn_{0.54}Co_{0.13}O₂ is used in the test of FIG. 5. Moreover, both tests are performed in a condition that the electrode size is 1 cm², and under 0.2 C and 0.5 C charge/discharge rate in respective, the specific capacity can achieve 120 mAh/g and 160 mAh/g, with the capacitance of 0.5˜1 mAh. Thus, by the solid electrolyte membrane of the present invention, the all-solid-state battery can be assembled and manufacture more rapidly and easily, and also the energy density of the resulting battery is improved.

In the all-solid-state battery, the solid electrolyte membrane and the manufacturing methods thereof that are provided in the present invention, no only the solid electrolyte membrane with ion conductivity larger than 1×10⁻⁴ S/cm that can function as an electrolyte layer is provided, but also the solid electrolyte membrane is able to function as a separator membrane by the characteristic of the solid polymer material doped in the solid electrolyte membrane. To sump up, the solid electrolyte membrane provided in the present invention can function as the combination of an electrolyte layer and a separator membrane.

In addition, since the solid elelctrolyte membrane can be proved to have good thermal stability and good electrochemical characteristic of wide electrochemical window, not only the problems troubling the conventional batteries using liquid electrolyte, such as safety issue and low working voltage, can be solved, but also the low ion conductivity that commonly seen in solid electrolyte of inorganic ceramic is solved.

Moreover, the cost for manufacturing the all-solid-state battery is reduce since there is neither separator membrane nor electrolytic solution needed to be used in the all-solid-state battery, and also, since the solid electrolyte membrane can be laminated between electrodes, the convenience regarding to the assembling of the all-solid-state battery is improved.

The aforesaid solid electrolyte membrane not only can be adapted for all-solid-state lithium battery that is small in size, high energy density and long lifespan, but also can be adapted for electrodes with high energy density, such as electrode of lithium-rich material or lithium-sulfur batteries, for eventually increasing the energy density of the resulting lithium battery using the electrodes.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A manufacturing method for solid electrolyte membrane, comprising the steps of:
providing a solution, while enabling the solution to be formed by heating a mixture of an electrolytic solution and a lithium salt;
adding a solid-state polymer material to the solution, while enabling the weight percentage of the solid-state polymer material in the solution to be maintained within 10%˜30%;
performing a heating and stirring process so as to dissolve the solid-state polymer material in the solution to form a viscous mass; and
performing a forming process for curing and forming the viscous mass into a solid electrolyte membrane.

2. The manufacturing method of claim 1, wherein the electrolytic solution is a solution selected from the group consisting of: a solution of ethylene carbonate, a solution of propylene carbonate, a solution of sulfolane, and a solution of succinonitirle.

3. The manufacturing method of claim 1, wherein the lithium salt is a material selection selected from the group consisting of: LiPF₆, LiClO₄, and LiTFSI.

4. The manufacturing method of claim 1, wherein the concentration of the lithium salt in the solution is ranged between 1 M˜2 M.

5. The manufacturing method of claim 1, wherein the solid polymer material is a material selected from the group consisting of: polyacrylonitrile, methyl methacrylate, polyvinylidene fluoride, and vinylidene fluoride-hexafluoropropylene.

6. The manufacturing method of claim 1, wherein the temperature is controlled to be ranged between 100° C. and 150° C. in the heating and stirring process.

7. The manufacturing method of claim 1, wherein the forming process further comprises the step of:
coating the viscous mass on a release paper.

8. The manufacturing method of claim 1, further comprising the following steps that are performed after the forming process:
performing a vacuuming process for removing moisture contained in the solid electrolyte membrane by situating the solid electrolyte membrane in a vacuum environment; and
performing a storing process for removing oxygen contained in the solid electrolyte membrane by storing the solid electrolyte membrane in an inert environment.

9. A manufacturing method for all-solid-state battery, comprising the steps of:
performing a procedure for manufacturing a solid electrolyte membrane, wherein the solid electrolyte membrane manufacturing procedure further comprises the steps of:
providing a solution, while enabling the solution to be formed by heating a mixture of an electrolytic solution and a lithium salt;
adding a solid-state polymer material to the solution, while enabling the weight percentage of the solid-state polymer material in the solution to be maintained within 10%˜30%;
performing a heating and stirring process so as to dissolve the solid-state polymer material in the solution to form a viscous mass; and
performing a forming process for curing and forming the viscous mass into a solid electrolyte membrane;
and
performing a lamination procedure for attaching a first electrode and a second electrode respectively to the two sides of the solid electrolyte membrane, while allowing the first electrode and the second electrode to have opposite polarity.

10. The manufacturing method of claim 9, wherein each of the first electrode and the second electrode includes a set layer and an active material.

11. The manufacturing method of claim 9, wherein the active material is a material selection selected from the group consisting of: LiMn₂O₄, LiCoO₂, LiFePO₄, LiNiO₂, Li_{1.2}Ni_{0.13}Mn_{0.54}Co_{0.13}O₂, S/PAN, S/C, C, Si, SnO₂, TiO₂, Li, and the derivatives, alloys and compounds thereof.

12. The manufacturing method of claim 9, wherein the electrolytic solution is a solution selected from the group consisting of: a solution of ethylene carbonate, a solution of propylene carbonate, a solution of sulfolane, and a solution of succinonitirle.

13. The manufacturing method of claim 9, wherein the lithium salt is a material selection selected from the group consisting of: LiPF₆, LiClO₄, and LiTFSI.

14. The manufacturing method of claim 9, wherein the concentration of the lithium salt in the solution is ranged between 1 M˜2 M.

15. The manufacturing method of claim 9, wherein the solid polymer material is a material selected from the group consisting of: polyacrylonitrile, methyl methacrylate, polyvinylidene fluoride, and vinylidene fluoride-hexafluoropropylene.

16. The manufacturing method of claim 9, wherein the temperature is controlled to be ranged between 100° C. and 150° C. in the heating and stirring process.

17. The manufacturing method of claim 9, wherein the forming process further comprises the step of:
coating the viscous mass on a release paper.

18. The manufacturing method of claim 9, further comprising the following steps that are performed after the forming process:
performing a vacuuming process for removing moisture contained in the solid electrolyte membrane by situating the solid electrolyte membrane in a vacuum environment; and
performing a storing process for removing oxygen contained in the solid electrolyte membrane by storing the solid electrolyte membrane in an inert environment.

19. An all-solid-state battery, comprising:
a solid electrolyte membrane, manufactured from a viscous mass, while the viscous mass that is formed by heating and stirring a solution added with a solid-state polymer material so as to dissolve the solid-state polymer material in the solution, moreover, the solution is formed by heating a mixture of an electrolytic solution and a lithium salt, and the weight percentage of the solid-state polymer material in the solution is maintained within 10%˜30%; and
a first electrode and a second electrode, to be disposed respectively attaching to the two sides of the solid electrolyte membrane, while allowing the first electrode and the second electrode to have opposite polarity.

20. The all-solid-state battery of claim 19, wherein each of the first electrode and the second electrode includes a set layer and an active material; and the active material is a material selection selected from the group consisting of: LiMn₂O₄, LiCoO₂, LiFePO₄, LiNiO₂, Li_{1.2}Ni_{0.13}Mn_{0.54}Co_{0.13}O₂, S/PAN, S/C, C, Si, Sn0₂, TiO₂, Li, and the derivatives, alloys and compounds thereof.
